(19) United States
(12) Patent Application Publication
(10) Pub. No.: US 2010/0230404 A1
(43) Pub. Date: Sep. 16, 2010

(54) Rack Assembly

(76) Inventor: Heinz Sigler, Cardiff (GB)

Correspondence Address: WOLFF LAW OFFICE, PLLC, P.O. BOX 9855, CHAPEL HILL, NC, 27515-9855, US

(21) Appl. No.: 12/305,963

(22) PCT Filed: Jun. 22, 2007
(86) PCT No.: PCT/EP07/05544

§ 371 Date: Dec. 20, 2008

(30) Foreign Application Priority Data
Jun. 22, 2006 (GB) 0612376.4

(51) Int. Cl. H05B 6/80; F24C 15/16

(52) U.S. Cl. 219/732; 126/337 R

(57) ABSTRACT

A rack assembly for a domestic appliance, comprising: a rack having a plurality of apertures distributed over the surface thereof; at least two supports, each of the supports being attached to the rack, each support being adapted for supporting the rack assembly in at least a first position and a second position; wherein the rack is attached to the supports in an asymmetric configuration, whereby, in use, the level of the rack is higher when the rack assembly is in the first position than in the second position. The supports may each comprise at least one leg and at least one foot, the legs being attached to the rack; wherein the legs are elongate, and the rack is attached to each of the legs at a point thereon that is closer to one end thereof than the other.

### BACKGROUND OF THE INVENTION

1. Field of the Invention

The present invention relates to domestic equipment, and more particularly to a rack assembly for domestic cooking appliances.

2. Discussion of The Related Art

It is conventional for microwave ovens, and other electrical domestic appliances, to include some sort of free standing rack assembly, typically to be mounted on top of a rotating platform within the oven, and used to support food, or a plate or other food container, during cooking. The rack assembly can be significant, for example, when a grill function is used, as it positions the food closer the grill element and can make heating and/or browning more effective. A known rack assembly is now discussed in relation to FIG. 1.

Referring to FIG. 1 (PRIOR ART), this shows a known rack assembly, generally designated 2, for a microwave oven. The rack assembly 2 consists of a rack 4 and three supports (legs) 6. The rack 4 comprises a circular frame 8 and a number of regularly spaced crossbars 10. The spacing 12 between the crossbars 10 is uniform and relatively wide; therefore, the rack assembly may support a plate or the like, but may only do so at a single height, and the wide spacings can make inappropriate for cooking smaller portions of foods, for example sausages.

A problem with a conventional rack assembly is that it is of relatively simple construction, it has only a single standing position or orientation, and so the available options are simply to use the oven with the rack assembly or without.

A further problem is that the flat perforated part of the rack assembly is also of simple construction, with regularly, perhaps widely spaced bars, meaning that small pieces of food are not stably supported during cooking and may fall through the spacings

### SUMMARY OF THE INVENTION

The present invention provides a rack assembly for a domestic appliance, comprising: a rack having a plurality of apertures distributed over the surface thereof; at least two supports, each of the supports being attached to the rack, each support being adapted for supporting the rack assembly in at least a first position and a second position; wherein the rack is attached to the supports in an asymmetric configuration, whereby, in use, the level of the rack is higher when the rack assembly is in the first position than in the second position.

Preferably, said at least two supports each comprise at least one leg and at least one foot, the legs being attached to the rack; wherein the legs are elongate, and the rack is attached to each of the legs at a point thereon that is closer to one end thereof than the other. Preferably, for each of the supports, the rack is attached at a point thereon that is about 10 to about 40% along the length thereof.

Preferably, the rack comprises a frame having a plurality of cross bars attached thereto and extending parallel to each other, the spacings between the crossbars forming said apertures. Suitably, the spacing between adjacent crossbars is between about 10 mm to about 25 mm

In one embodiment, the spacing between adjacent crossbars is smaller at the midpoint of the rack than at the edges of the rack. The spacing between adjacent crossbars may be, for example, between about 10 mm to about 15 mm at the midpoint of the rack and between about 20 mm to about 25 mm at the edges of the rack.

In another embodiment, the spacing between adjacent crossbars varies gradually from said midpoint to said ends.

In one embodiment, the rack has at least four sides, e.g. is square or rectangular, a support being attached to at least two of the sides. Preferably, each support comprises a pair of legs and a pair of feet. The rack may be generally rectangular and have two short sides to which the supports are attached. Preferably, the cross bars extend between the two long sides of the rectangular rack.

In another embodiment, the rack is generally circular and comprises at least three supports.

The supports may comprise rod-like members and the feet may comprise resilient members, one resilient member being attached to each end of the rod-like member.

Suitably, the appliance is a microwave oven, or an oven incorporating any combination of convention, microwave, steam or grill, or any other suitable cooking technique.

An advantage of the invention is that the rack assembly can be placed either in an orientation in which the rack is relatively high (useful for cooking bacon, sausages, burgers, toast, etc.) and an orientation in which the rack is relatively low (useful for cooking a whole or half chicken, or a joint of meat, etc.). Thus two levels of cooking are provided by one assessory.

The invention is particularly beneficial as an accessory for microwave ovens and smaller cooking appliances that include a grill function.

A further advantage is that the supports not only provide rigidity and support to the accessory but also feature as handles. This allows for easier and safer handling of the accessory when inserting and removing from the cooking appliance.

The invention advantageously, through the use of different sized apertures, or different or variable spacings between crossbars, enables food of various types and sizes to be supported.

### BRIEF DESCRIPTION OF THE DRAWINGS

Embodiments of the invention will now be described in detail, by way of example, with reference to the accompanying drawings, in which:

FIG. 1 (PRIOR ART) shows a known rack assembly for a microwave oven;

FIG. 2 illustrates a rack assembly in accordance with an embodiment of the present invention (a) in a “high-rack” orientation and (b) in a “low-rack” orientation;

FIG. 3 FIG. 3 depicts alternative embodiments of the rack for the rack assembly of FIG. 2, (a) using punched rectangles, and (b) using punched holes; and

FIG. 4 is an end view of an alternative form of supports in another embodiments of the invention;

FIG. 5 illustrates a further embodiment of the invention, using alternative supports; and

FIG. 6 illustrates a further embodiment of the invention, using a non-rectangular rack.

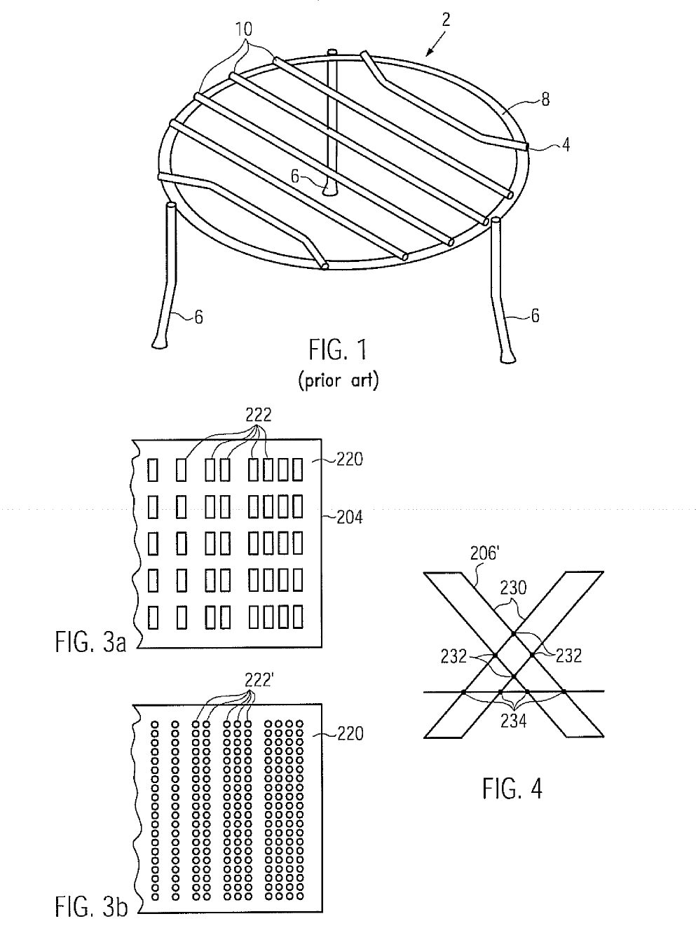

In the description and drawings, like numerals are used to designate like elements.

### DETAILED DESCRIPTION OF THE PREFERRED EMBODIMENTS

This invention concerns a rack assembly usable in domestic cooking appliances which devices may include one or more of the following cooking techniques: convention, microwave, steam, grill, and so forth, or any combination thereof. The invention is, for example, particularly beneficial in relation to microwave ovens. However, the invention is applicable to a wide range of cooking appliances, whether freestanding or adapted for built-in installation, i.e. installed within a framework or outer housing, or are mounted with kitchen or other household furniture (sometimes known as “slot-in” or “built-in” appliances).

The present invention provides a rack assembly for a domestic appliance, comprising: a rack having a plurality of apertures distributed over the surface thereof; at least two supports, each of the supports being attached to the rack, each support being adapted for supporting the rack assembly in at least a first position and a second position; wherein the rack is attached to the supports in an asymmetric configuration, whereby, in use, the level of the rack is higher when the rack assembly is in the first position than in the second position.

Preferably, said at least two supports each comprise at least one leg and at least one foot, the legs being attached to the rack; wherein the legs are elongate, and the rack is attached to each of the legs at a point thereon that is closer to one end thereof than the other. Preferably, for each of the supports, the rack is attached at a point thereon that is about 10 to about 40% along the length thereof.

Preferably, the rack comprises a frame having a plurality of cross bars attached thereto and extending parallel to each other, the spacings between the crossbars forming said apertures. Suitably, the spacing between adjacent crossbars is between about 10 mm to about 25 mm.

In one embodiment, the spacing between adjacent crossbars is smaller at the midpoint of the rack than at the edges of the rack. The spacing between adjacent crossbars may be, for example, between about 10 mm to about 15 mm at the midpoint of the rack and between about 20 mm to about 25 mm at the edges of the rack.

In another embodiment, the spacing between adjacent crossbars varies gradually from said midpoint to said ends.

In one embodiment, the rack has at least four sides, e.g. is square or rectangular, a support being attached to at least two of the sides. Preferably, each support comprises a pair of legs and a pair of feet. The rack may be generally rectangular and have two short sides to which the supports are attached. Preferably, the cross bars extend between the two long sides of the rectangular rack.

In another embodiment, the rack is generally circular and comprises at least three supports.

The supports may comprise rod-like members and the feet may comprise resilient members, one resilient member being attached to each end of the rod-like member.

Suitably, the appliance is a microwave oven, or an oven incorporating any combination of convention, microwave, steam or grill, or any other suitable cooking technique.

An advantage of the invention is that the rack assembly can be placed either in an orientation in which the rack is relatively high (useful for cooking bacon, sausages, burgers, toast, etc.) and an orientation in which the rack is relatively low (useful for cooking a whole or half chicken, or a joint of meat, etc.). Thus two levels of cooking are provided by one assessory.

The invention is particularly beneficial as an accessory for microwave ovens and smaller cooking appliances that include a grill function.

A further advantage is that the supports not only provide rigidity and support to the accessory but also feature as handles. This allows for easier and safer handling of the accessory when inserting and removing from the cooking appliance.

The invention advantageously, through the use of different sized apertures, or different or variable spacings between crossbars, enables food of various types and sizes to be supported.

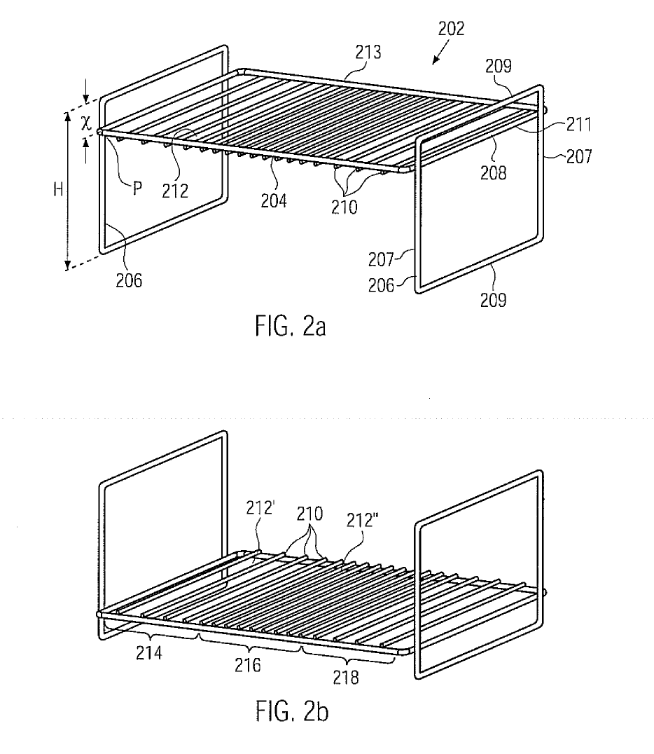

FIG. 2 illustrates a rack assembly, generally designated 202, in accordance with an embodiment of the present invention. FIG. 2(a) shows the rack assembly 202 in a “high-rack” orientation, suitable for cooking bacon, sausages, burgers, toast, etc. The rack assembly 202 consists of a rack 204 and two supports 206, each support comprising two legs 207 and two “feet” 209. The rack 204 comprises a rectangular frame 208 and a number of spaced crossbars 210. (Alternatively, the frame 208 is square.) The rack assembly 202 is suitably made of thick metal wire (e.g. chrome plated steel), of thickness about 3-4 mm, or more if greater strength is required. The crossbars 210 are suitably attached to the frame 208, and the frame 208 attached to the supports 206, by welding or other suitable fixation technique.

Although shown attached to the short sides 211 of the frame 208, in an alternative embodiment the supports 206 may be attached to the long sides 213 of the frame 208.

The supports 206 are generally square (but may be rectangular), and the point P at which the frame 208 is attached to the supports 206 is at a distance x from the top of the support 206, which has a height H. According to the invention, the rack 208 is not located at the top, or half way up height H, but, in the illustrated example, (x/H)×100 is approximately 25%. However, (x/H)×100 may be approx. 10-40%.

This asymmetric design means that when the rack assembly 202 is inverted, into a second possible orientation (FIG. 2(b)), the rack 204 is at a low level (suitable for cooking a whole or half chicken, or a joint of meat, etc.).

Although the spacing 212 between the crossbars 210 may be uniform, in the illustrated embodiment it is non-uniform. Referring again to FIG. 2(b), the rack 204 is divided into three sections, 214, 216 and 218. In the outer sections 214 and 218, the spacings 212′ between the crossbars 210 are relatively large (approx 20 to 25 mm), while in the centre section 216, the spacings 212″ between the crossbars 210 is relatively small (approx 10 to 15 mm) In an alternative form, the spacing 212 may vary, from a small size at the centre, gradually along the rack 204 to a larger size at the ends. Such configurations mean there is greater support in the middle, for the centre of gravity of a large object such a chicken or joint of meat.

FIG. 3 depicts alternative embodiments of the rack 204 for the rack assembly 202 of FIG. 2, (a) using punched rectangles, and (b) using punched holes (only part of the rack 204 is shown). In FIG. 3(a), the rack comprises a flat plate 220 (e.g. steel, aluminium, plated steel or enamelled steel), in which rectangular holes 222 have been punched (using conventional techniques) during the manufacturing process. In FIG. 2(b), the rack 204 has the same form as in FIG. 3(a), except that the punched holes 222′ are circular.

FIG. 4 is an end view of an alternative form of supports 206′ in another embodiment of the invention. This is the same as the first mentioned embodiment, except that the supports 206′ are in the shape of an “X”, rather than being square. Each support 206′ comprises two sections 230 which are welded at points 232, the rack 204 being welded to the supports 206′ at points 234.

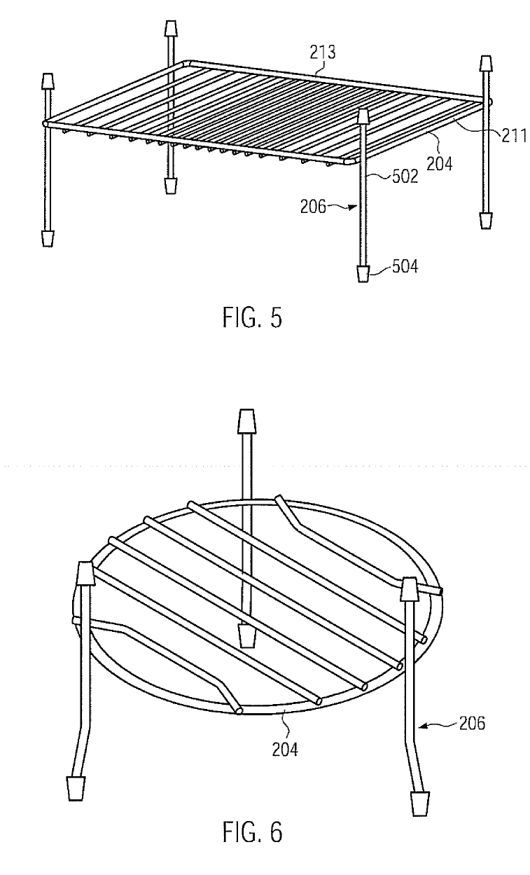

FIG. 5 illustrates a further embodiment of the invention. This is the same as the embodiment of FIG. 2, except that the supports 206 comprise rod-like members 502, each member 502 having an end-member or foot 504 attached to each end thereof. A pair of members 502 is attached to each of the short sides 211 of the rack 204. The end-members 504 suitably comprise rounded or conically tapering feet, for example made of rubber or silicone rubber. Again, the rod-like members 502 could equally be attached to the long sides 213 of the rack 204.

FIG. 6 illustrates a further embodiment of the invention. This is the same as the other embodiments, except that the rack 204 is round. The supports 206 are the same as in the embodiment of FIG. 5.

1. A rack assembly for a domestic appliance, comprising:
a rack having a plurality of apertures distributed over the surface thereof;
at least two supports, each of the supports being attached to the rack, each support being adapted for supporting the rack assembly in at least a first orientation and a second orientation within a microwave oven, the second orientation being different to the second orientation;
wherein the rack is attached to the supports in an asymmetric configuration, whereby, in use, the level of the rack is higher when the rack assembly is in the first orientation than in the second orientation.

2. The rack assembly of claim 1, wherein:
said at least two supports each comprise at least one leg and at least one foot, the legs being attached to the rack;
wherein the legs are elongate, and the rack is attached to each of the legs at a point thereon that is closer to one end thereof than the other.

3. The rack assembly of claim 1, wherein, for each of the supports, the rack is attached at a point thereon that is about 10 to about 40% along the length thereof.

4. The rack assembly of claim 1, wherein the rack comprises a frame having a plurality of cross bars attached thereto and extending parallel to each other, the spacings between the crossbars forming said apertures.

5. The rack assembly of claim 4, wherein the spacing between adjacent crossbars is between about 10 mm to about 25 mm.

6. The rack assembly of claim 4, wherein the spacing between adjacent crossbars is smaller at the midpoint of the rack than at the edges of the rack.

7. The rack assembly of claim 6, wherein the spacing between adjacent crossbars is between about 10 mm to about 15 mm at the midpoint of the rack and between about 20 mm to about 25 mm at the edges of the rack.

8. The rack assembly of claim 6, wherein the spacing between adjacent crossbars varies gradually from said midpoint to said ends.

9. The rack assembly of claim 1, wherein the rack has at least four sides, e.g. is square or rectangular, a support being attached to at least two of the sides.

10. The rack assembly of claim 9, wherein each support comprises a pair of legs and a pair of feet.

11. The rack assembly of claim 9, wherein the rack is generally rectangular and has two short sides to which the supports are attached.

12. The rack assembly of claim 11, wherein the cross bars extend between two long sides of the rectangular rack.

13. The rack assembly of claim 1, wherein the rack is generally circular and comprises at least three supports.

14. The rack assembly of claim 2, wherein the supports comprise rod-like members and the feet comprise resilient members, one resilient member being attached to each end of the rod-like member.

15. The rack assembly of claim 1, wherein the second orientation is substantially opposite to the first orientation.

16. A cooking, grilling or oven rack assembly for a domestic appliance, comprising:
a rack having a plurality of apertures distributed over a surface thereof;
at least two supports for supporting the rack assembly, each of the supports being attached to the rack in an asymmetric configuration so that the rack in use has a level that is raised higher in at least a first orientation than in a second orientation, the first orientation being substantially opposite to the second orientation, and the rack being raised up by the at least two supports in both the first orientation and second orientation.

17. The rack assembly of claim 16, wherein the rack is generally rectangular and has two short sides to which the supports are attached.

18. The rack assembly of claim 17, wherein the rack is generally circular and comprises at least three supports.

19. A microwave oven rack assembly, comprising:
a rack having a plurality of apertures distributed over a surface thereof that are spaced at varying distances from one another based on their location across the length of the surface;
at least two supports for supporting the rack assembly, each of the supports being attached to the rack in an asymmetric configuration so that the rack in use has a level that is raised higher in at least a first orientation than in a second orientation, the first orientation being substantially opposite to the second orientation, and the rack being raised up by the at least two supports in both the first orientation and second orientation.

20. The rack assembly of claim 19, wherein the rack comprises a frame having a plurality of cross bars attached thereto and extending parallel to each other, the spacings between the crossbars forming said apertures.
